(19) United States
(12) Patent Application Publication
(10) Pub. No.: US 2017/0260799 A1
(43) Pub. Date: Sep. 14, 2017

(54) FENESTRATION MEMBER SEALING SYSTEM

(71) Applicant: Westhampton Architectural Glass, Inc., Westhampton Beach, NY (US)

(72) Inventors: Paul T. Siller, Remsenburg, NY (US); Robert B. Busking, JR., Remsenburg, NY (US); Robert Busking, SR., Westhampton Beach, NY (US)

(21) Appl. No.: 15/067,718

(22) Filed: Mar. 11, 2016

(51) Int. Cl. E06B 7/205; E06B 7/21

(52) U.S. Cl. CPC E06B 7/205; E06B 7/21; E06B 2007/202

(57) ABSTRACT

The system includes a gear mounted for rotation relative to the fenestration member. A mechanical linkage connects the latch control member and the gear such that the gear is rotated from a first position, where the latch is disengaged, to a second position as the latch is moved to engage the fenestration member frame. A rack in engagement with the gear is mounted to a first bar for linear movement in a given direction as the gear is rotated. A first triangular member moves with the rack. A second triangular member attached to a second bar cooperates with the first triangular member to move the second bar in a direction substantially perpendicular to the direction of rack movement. A gasket moves with the second bar to a position abutting the adjacent surface to automatically seal the member to the adjacent surface as the member is latched.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to weather-proof constructions for doors, windows or other fenestration members and more particularly to a construction which includes a system for sealing the bottom or side of the fenestration member to an adjacent surface such as the threshold saddle, frame or jamb when the fenestration member is closed.

2. Description of Prior Art Including Information Disclosed Under 37 CFR 1.97 and 1.98

Various methods have been used to weather strip doors, windows or other fenestration members to avoid air from entering a building or other enclosure through the gap between the fenestration member and the adjacent surfaces including the saddle, jamb or frame when the fenestration member is closed. Strips of insulating products such as metal, felt, foam, rubber or other resilient materials have been attached to the fenestration member or surfaces adjacent the fenestration member in order to seal the gap between the fenestration member and those surfaces. Metal strips with rubber gaskets have been attached to the fenestration member such that they extend over the gap to prevent air from entering beneath or around the fenestration member when the fenestration member is closed. However, regardless of the materials or configurations, stationary strips must allow sufficient clearance for the fenestration member to open and close without interference and thus cannot seal the fenestration member completely.

Elongated articles of insulating material of different sizes and shapes have also been placed against the bottom of the fenestration member to prevent air from passing under the fenestration member. However, those articles must be removed each time when the fenestration member is opened.

Because none of those methods have proved satisfactory, there is a need for a system which will create a highly effective seal between the fenestration member and adjacent surfaces of fenestration member frame, jamb or saddle when the fenestration member is closed and automatically retract when the fenestration member is unlatched to allow the fenestration member to be opened without interference.

It is, therefore, a prime object of the present invention to provide a fenestration member sealing system.

It is another object of the present invention to provide a fenestration member sealing system which includes a gasket mounted to the fenestration member which is moved from a position remote from the adjacent surface of the fenestration member frame or saddle to a sealing position abutting the adjacent surface to seal the gap between the fenestration member and the adjacent surface.

It is another object of the present invention to provide an automatic fenestration member sealing system which includes a gasket mounted to the fenestration member which is automatically moved to a position abutting the adjacent surface as the fenestration member is latched.

It is another object of the present invention to provide an automatic fenestration member sealing system which includes a gasket mounted to the fenestration member which is automatically moved to the abutting position by a mechanism including oppositely oriented triangular members with inclined surfaces which cooperate to cause the gasket to move to the abutting position as the fenestration member is latched.

It is another object of the present invention to provide an automatic fenestration member sealing system which includes a gasket mounted to the fenestration member which is automatically moved to the abutting position by a mechanism which includes a rack and gear assembly.

It is another object of the present invention to provide an automatic fenestration member sealing system which includes a gasket mounted to the fenestration member which is automatically moved to the abutting position by an internal mechanical linkage extending between the fenestration member latch control and the structure that moves the gasket as the fenestration member is latched.

### BRIEF SUMMARY OF THE INVENTION

In general, the above noted objects are achieved by the present invention which relates to a system for sealing a fenestration member to an adjacent frame surface such as a saddle, jamb or frame. The fenestration member has a latch and a member which controls the position of the latch to engage or disengage the fenestration member frame. The system includes a gear mounted for rotation relative to the fenestration member. A mechanical linkage connects the latch control member and the gear such that the gear is rotated from a first position, where the latch is disengaged, to a second position as the latch is moved to engage the fenestration member frame. A rack in engagement with the gear is mounted to the fenestration member for linear movement in a given direction as the gear is rotated. A first triangular member moves with the rack. A second triangular member cooperates with the first triangular member to move the second triangular member in a direction substantially perpendicular to the direction of rack movement. A gasket moves with the second cam member to a position abutting the adjacent frame surface to seal the fenestration member as the latch is moved to engage the fenestration member frame.

The first triangular member includes an inclined surface. The second triangular member includes a second inclined surface. The first inclined surface and the section inclined surface cooperate to move the gasket toward and away from the adjacent fenestration member surface.

A spring connects extends between the gasket and the fenestration member. The spring urges the first triangular member and the second triangular member toward each other.

The rack and the first triangular member are mounted on a bar. The bar extends across and is movable along the fenestration member. The bar has an opening aligned with the spring such that the spring does not interfere with the movement of the bar.

Means are provided for preventing the gasket from moving relative to the fenestration member in the direction of rack movement.

In accordance with another aspect of the present invention, a system for sealing a fenestration member to an adjacent surface such as a fenestration member saddle, jamb or frame. The fenestration member has a latch and a member which controls the position of the latch to engage or disengage the fenestration member frame. The system includes a gear mounted for rotation relative to the fenestration member. A mechanical linkage connects the latch control member and the gear such that the gear is rotated from a first position, where the latch is disengaged, to a second position as the latch is moved to engage the fenestration member frame. A rack in engagement with the gear is mounted on a first bar for linear movement in a given direction as the gear is rotated. First and second triangular member sets are provided. Each triangular member set includes a first triangular member and a second triangular member. The first triangular member of each set moves with the first bar. The second triangular member of each set is mounted on a second bar and cooperates with the first triangular member of that set to move the second bar in a direction substantially perpendicular to the direction of movement of the first bar. A gasket moves with the second bar to a position abutting the adjacent frame surface to seal the fenestration member as the latch is moved to engage the fenestration member frame.

The first triangular member of each triangular member set includes an inclined surface. The second triangular member of each of triangular member set includes a second inclined surface. The first inclined surface and the second inclined surface of the triangular members of each triangular member set cooperate to move the second bar toward and away from the adjacent surface.

The system includes first and second spaced springs connecting the first bar and the second bar. The springs urge the first triangular member and the second triangular member of each triangular member set toward each other.

The first bar includes first and second openings aligned with the first and second springs, respectively, such that the springs do not interfere with the movement of the first bar.

The system includes means for preventing the second bar from moving in a direction substantially parallel to the first bar.

The system includes a rubber layer or gasket on the second bar.

In accordance with another aspect of the present invention, a combination of a fenestration member and system for sealing the fenestration member to an adjacent surface is provided. The fenestration member is associated with a frame and includes a latch and a member for controlling the position of the latch to engage and disengage the frame. The system includes a gear mounted for rotation relative to the fenestration member between a first position and a second position. A mechanical linkage connects the latch control member and the gear such that the gear is rotated from a first position wherein the latch does not engage the frame to a second position as the latch engages the frame. The gear engages a rack to move in a given direction as the gear is rotated between its first position and its second position. A first triangular member is movable with the rack. A second triangular member cooperates with the first triangular member to move the second triangular member in a direction substantially perpendicular to the direction of rack movement. A gasket is movable with the second triangular member to position abutting the adjacent frame surface to seal the fenestration member as the latch engages the frame.

### BRIEF DESCRIPTION OF THE SEVERAL VIEWS OF DRAWINGS

To these and to such other objects that may hereinafter appears, the present invention relates to an automatic fenestration member sealing system as described in detail in the following specification and recited in the annexed claims, taken together with the accompanying drawings, in which like numerals refer to like parts and in which:

FIG. 1 is an elevation view of the interior of a door with the fenestration member sealing system, showing the gasket in a position remote from the adjacent frame surface of the door saddle;

FIG. 2 is an elevation view of the door of FIG. 1, showing the gasket in a position abutting the adjacent frame surface of the door saddle; and

FIG. 3 is a cross-sectional view of the bottom of the door of FIG. 1.

### DETAILED DESCRIPTION OF THE INVENTION

For purposes of explanation, the preferred embodiment of the present invention is described and illustrated as it would be used to seal a fenestration member in the form of a door to an adjacent surface such as a saddle, jamb or frame against air passing around the door, through an entranceway and into a building. However, it should be understood that the present invention could be used to seal any type of fenestration member, such as a window, to an adjacent frame surface. Further, the seal created by the present invention could also be used to prevent water, dust particles, odors, fumes and the like from entering the building, as well as air.

Moreover, the present invention is intended for use with any type of fenestration member having a moveable latch control member. Such a moveable latch control member could take the form of a rotatable or moveable knob, lever or handle.

As seen in the drawings, the preferred embodiment of the sealing system of the present invention is designed for use on a fenestration member such as a door 10 which has a rotatable door knob 12 accessible from the exterior of the door. Door knob 12 controls the position of a latch 14 which is moved toward and away from an opening in door frame 16 to engage or disengage the door frame.

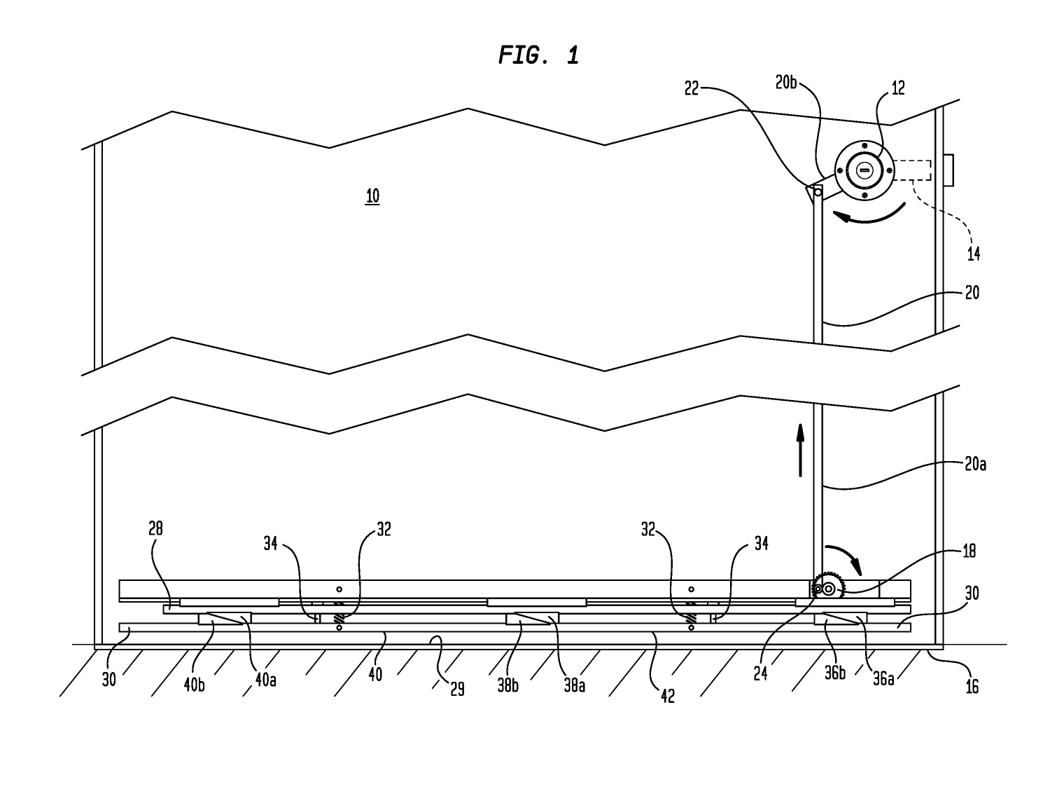

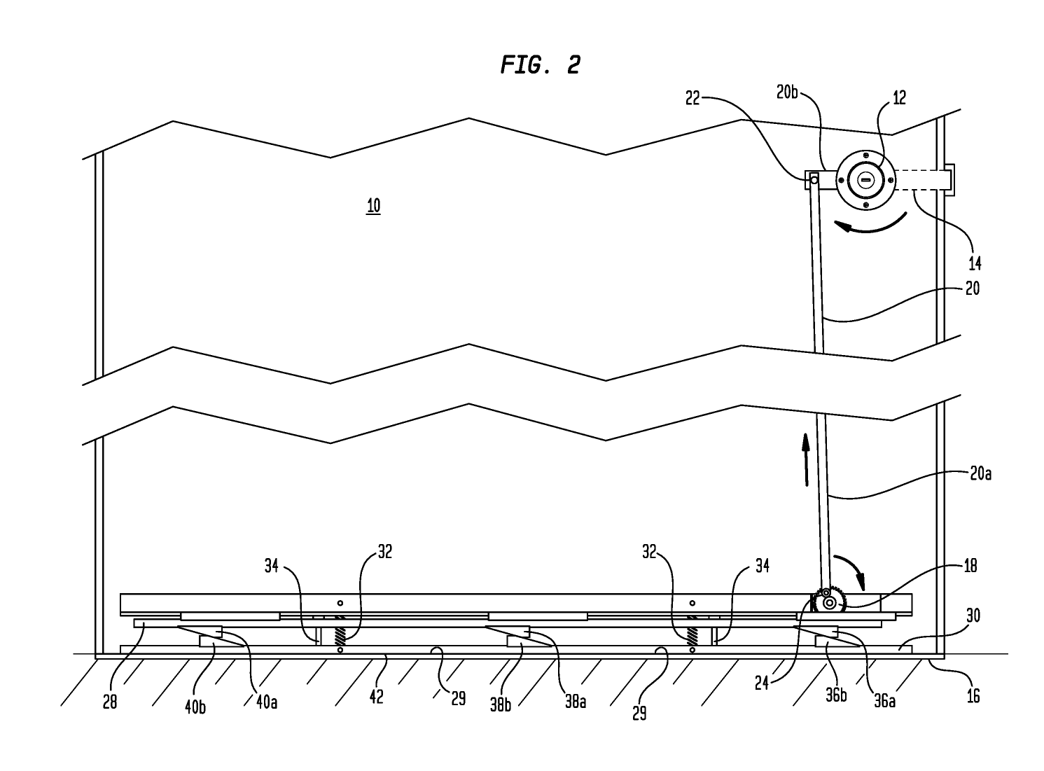

Inside the door is a gear 18 mounted near the bottom of the door for rotation relative to the door between a first position wherein the latch is withdrawn and the door is disengaged from the door frame such that the door can be opened (as seen in FIG. 1) and a second position wherein the latch is extended and engages the door frame to keep the door closed (as seen in FIG. 2).

A mechanical linkage, generally designated 20, extends within the door to connect knob 12 and gear 18. As knob 12 is rotated in a clockwise direction from its first position shown in FIG. 1 in which the door is unlatched to its second position shown in FIG. 2 in which the door is latched, gear 18 is rotated in a clockwise direction from its first position shown in FIG. 1 to its second position shown in FIG. 2. Linkage 20 includes an elongated main section 20a connected at its upper end by a pivot pin 22 to a link 20b which moves with knob 12, and at is lower end by a pivot pin 24 extending from the surface of gear 18.

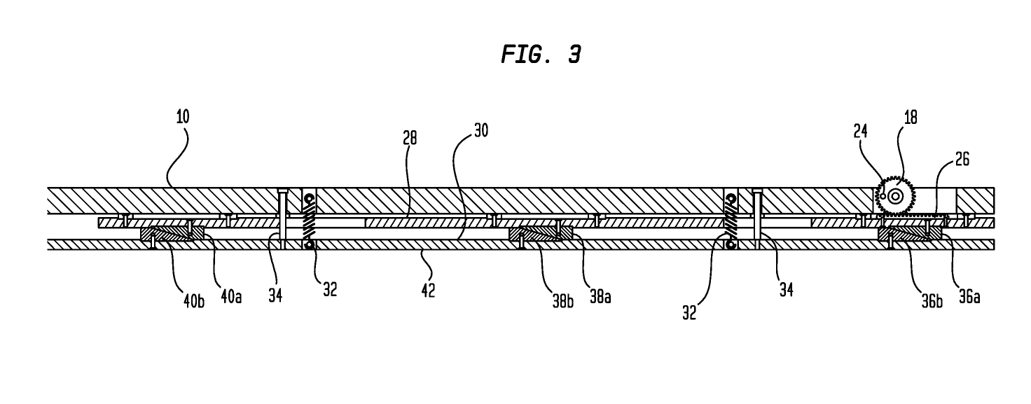

As best seen in FIG. 3, a rack 26 is mounted on a first bar 28 at a position wherein the rack is engaged by gear 18. As gear 18 is rotated, rack 26, and the first bar 28 to which the rack is attached, moves in a linear path substantially parallel to but spaced from surface 29 of saddle.

A second bar 30 is mounted below and spaced a short distance from first bar 28. Second bar 30 is connected to first bar 28 at two locations by assemblies that allow the second bar to move toward and away from first bar 28 but not in a direction parallel to first bar 28.

Each of the bar connecting assemblies includes a spring 32 and a bolt 34. In each assembly, spring 32 urges second bar 30 toward first bar 28. Each bolt 34 has an enlarged head which is captured in a bore hole in first bar 28 having an opening smaller than the bolt head such that the bolt can move up and down within the bore but not exit the bore opening. In this manner, second bar 30 and can move relative to first bar 28 only in a direction which is substantially perpendicular to the adjacent saddle surface 29.

Springs 32 urge second bar 30 toward first bar 28 in order to maintain contact between the inclined surfaces of oppositely oriented triangular shaped members. The triangular members form spaced triangular member sets, three of which are shown. Each triangular member set 36, 38 and 40 includes two triangular members which cooperate to regulate the vertical distance between the first and second bars.

Triangular member set 36 includes triangular members 36a and 36b. Triangular member set 38 includes triangular members 38a and 38b. Triangular member set 40 includes triangular members 40a and 40b. In each triangular member set, the upper triangular member 36a, 38a and 40a is attached to first bar 28 and the lower triangular member 36b, 38b and 40b is attached to second bar 30.

Rack 26 and the upper triangular members 36a, 38a and 40a of each set are attached to and move with the first bar 28, as gear 18 is rotated. Because the lower triangular members are mounted on and move with the second bar, and the second bar can only move in a direction perpendicular to the path of movement of first bar 28, as the first bar 28 moves, the upper and lower triangular members in each triangular member set cooperate to move second bar 30 toward and away from the first bar 28.

A rubber gasket or layer 42 is attached to the bottom of second bar 30. When second bar 30 is moved to its position abutting saddle surface 29, rubber gasket or layer 42 will press against the surface of the door saddle and seal the bottom of the door to the saddle surface, as illustrated in FIG. 2.

When knob 12 is rotated to unlatch the door, mechanical linkage 20 will rotate gear 18. The rotation of gear 18 will cause rack 26 and thus first bar 28 to move back to the position seen in FIG. 1. That will cause the triangular members to move back to their original positions and second bar 30 to move away from the saddle such that the door is no longer sealed and can be opened.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

We claim:

1. A system for automatically sealing a door, window or other fenestration member to an adjacent surface, the fenestration member having a latch and a member which controls the position of the latch to engage or disengage the fenestration member frame, the system comprising a gear mounted for rotation relative to the fenestration member, a mechanical linkage connecting the latch control member and said gear such that said gear is rotated from a first position, where the latch is disengaged, to a second position as the latch is moved to engage the fenestration member frame, a rack in engagement with said gear mounted to the fenestration member for linear movement in a given direction as said gear is rotated, a first triangular member movable with said rack, a second triangular member cooperating with said first triangular member to move said second triangular member in a direction substantially perpendicular to the direction of said rack movement, and a gasket movable with said second triangular member to a position abutting the adjacent frame surface to seal the fenestration member as the latch is moved to engage the fenestration member frame.

2. The system of claim 1 wherein said first triangular member comprises an inclined surface.

3. The system of claim 2 wherein said second triangular member comprises a second inclined surface.

4. The system of claim 3 wherein said first inclined surface and section inclined surface cooperate to move said gasket toward and away from the surface adjacent the fenestration member.

5. The system of claim 1 further comprising a spring connecting said gasket and the fenestration member.

6. The system of claim 5 wherein said spring urges said first triangular member and said second triangular member toward each other.

7. The system of claim 5 wherein said rack and said first triangular member are mounted on a bar which extends across and is movable along the fenestration member.

8. The system of claim 7 wherein said bar comprises an opening aligned with said spring.

9. The system of claim 1 further comprising means for preventing said gasket from moving relative to the bottom of the door in said first direction.

10. A system for sealing a door, window or other fenestration member to an adjacent surface, the fenestration member having a latch and a member which controls the position of the latch to engage or disengage the fenestration member frame, the system comprising a gear mounted for rotation relative to the fenestration member, a mechanical linkage connecting the latch control member and said gear such that said gear is rotated from a first position, where the latch is disengaged, to a second position as the latch is moved to engage the fenestration member frame, a rack in engagement with said gear mounted on a first bar for linear movement in a given direction as said gear is rotated, first and second triangular member sets, each of said triangular member sets comprising a first triangular member and a second triangular member, said first triangular member of each said triangular member set moving with said first bar, said second triangular member of each said triangular member set being mounted on a second bar and cooperating with said first triangular member of that triangular member set to move said second bar in a direction substantially perpendicular to the direction of movement of said first bar, and a gasket movable with said second bar to a position abutting the adjacent frame surface to seal the fenestration member as the latch is moved to engage the fenestration member frame.

11. The system of claim 10 wherein said first triangular member of each of said triangular member sets comprises an inclined surface.

12. The system of claim 11 wherein said second triangular member of each of said triangular member sets comprises a second inclined surface.

13. The system of claim 12 wherein said first inclined surface and said second inclined surface of said triangular members of each of said triangular sets cooperate to move said second bar toward and away from the surface of said fenestration member.

14. The system of claim 10 further comprising first and second spaced springs connecting said second bar and the bottom of the fenestration member.

15. The system of claim 14 wherein said springs urge said first triangular member and said second triangular member of each triangular member set toward each other.

16. The system of claim 15 wherein said first bar comprises first and second openings aligned with said springs, respectively.

17. The system of claim 10 further comprising means for preventing said second bar from moving in a direction substantially parallel to the fenestration member.

18. The system of claim 10 further comprising a rubber layer on said second bar.

19. In combination, a door, window or other fenestration member and a system for sealing the fenestration member to an adjacent surface, said fenestration member comprising a latch and a member for controlling the position of the latch to engage and disengage the fenestration member frame, said system comprising a gear mounted for rotation relative to said fenestration member, a mechanical linkage connecting said latch control member and said gear such that said gear is rotated from a first position wherein the latch does not engage the fenestration member frame to a second position as the latch engages the fenestration member frame, said gear engaging a rack to move said rack in a given direction as said gear is rotated from its first position to its second position, a first triangular member movable with said rack, a second triangular member cooperating with said first triangular member to move said second triangular member in a direction substantially perpendicular to the direction of rack movement, and a gasket movable with said second triangular member to position abutting said adjacent frame surface to seal said fenestration member as said latch engages the fenestration member frame.
